(19) United States
(12) Patent Application Publication
(10) Pub. No.: US 2021/0170688 A1
(43) Pub. Date: Jun. 10, 2021

(54) MODULES OF THREE-DIMENSIONAL (3D) PRINTERS

(71) Applicant: Hewlett-Packard Development Company, L.P., Spring, TX (US)

(72) Inventors: Kristopher J Erickson, Palo Alto, CA (US); Lihua Zhao, Palo Alto, CA (US); Jonathan Salfity, Palo Alto, CA (US)

(73) Assignee: Hewlett-Packard Development Company, L.P., Spring, TX (US)

(21) Appl. No.: 17/047,295

(22) PCT Filed: Aug. 27, 2018
(86) PCT No.: PCT/US2018/048164

§ 371 Date: Oct. 13, 2020

(51) Int. Cl. B29C 64/379; G05B 19/402; B33Y 50/02; B33Y 30/00; B22F 12/00; B22F 10/85; B29C 64/393; B29C 64/227; B28B 1/00; B33Y 40/00

(52) U.S. Cl. CPC B29C 64/379; G05B 19/402; B33Y 50/02; B33Y 30/00; B22F 12/22; G05B 2219/36262; B29C 64/393; B29C 64/227; B28B 1/001; B33Y 40/00; G05B 2219/49023; B22F 10/85

(57) ABSTRACT

In some examples, an interaction module of a three-dimensional (3D) printer can include an interaction sub-module including a coupler, where the coupler is to connect to a tool, a first actuator to move the coupler in a first direction, and a second actuator to move the coupler in a second direction, and an analytics system to analyze the coupler and the tool during an interaction with a 3D object of the 3D printer, where the tool of the coupler is to interact with the 3D object of the 3D printer during a 3D print job.

### BACKGROUND

A three-dimensional (3D) printer may be used to create different 3D objects. 3D printers may utilize additive manufacturing techniques to create the 3D objects. For instance, a 3D printer may deposit material in successive layers in a build area of the 3D printer to create a 3D object. The material can be selectively fused, or otherwise solidified, to form the successive layers of the 3D object.

### BRIEF DESCRIPTION OF THE DRAWINGS

FIG. 1 illustrates a perspective view of an example of an interaction module of a 3D printer consistent with the disclosure.

FIG. 2 illustrates a perspective view of an example of an interaction preparation module of a 3D printer consistent with the disclosure.

FIG. 3 illustrates a perspective view of an example of a system consistent with the disclosure.

FIG. 4A illustrates an example of a 3D print job with modules of a 3D printer consistent with the disclosure.

FIG. 4B illustrates an example of a 3D print job with modules of a 3D printer consistent with the disclosure.

FIG. 4C illustrates an example of a 3D print job with modules of a 3D printer consistent with the disclosure.

FIG. 4D illustrates an example of a 3D print job with modules of a 3D printer consistent with the disclosure.

### DETAILED DESCRIPTION

Some 3D printers can utilize a build material to create 3D objects that has a powdered and/or granular form. The 3D printer may apply build material in successive layers in a build area to create 3D objects. The build area may include a build platform. The build material can be fused, and a next successive layer of build material may be applied to the build platform of the build area.

As used herein, the term “3D printer” can, for example, refer to a device that can create a physical 3D object. For example, a 3D printer can include a multi-jet fusion 3D printer, among other types of 3D printers. In some examples, the 3D printer can create the 3D object utilizing a 3D digital model. The 3D printer can create the 3D object by, for example, depositing a build material such as powder, and a fusing agent in a build area of the 3D printer. The build material may be deposited in successive layers in the build area and build material included in the successive layers can absorb energy from a lamp as a result of the fusing agent to fuse the successive layers to create the 3D object.

During a 3D print job of a 3D object, it may be desired to interact with the 3D object being printed during the 3D print job. For example, interaction with the 3D object during the 3D print job may include modification of the 3D object (e.g., by adding and/or removing build material from the 3D object), placement of components or parts in the 3D object being printed, and/or adding different types of materials in the 3D object being printed such as silver paste or solder flux paste. For example, the 3D object may be designed to be an electronic device including electronic components. The electronic components, as well as connections between those electronic components, may be desired to be placed in the 3D object.

However, manual interaction with a 3D object during a 3D print job of the 3D object may cause undesired side effects in the 3D object. For instance, in order to manually place a component in the 3D object being created during a 3D print job, portions of the 3D print job may have to be delayed in order to add and/or remove build material and/or place the component in the 3D object. For example, deposition of layers of build material while components are manually placed in the 3D object during the 3D print job can delay the 3D print job, increasing the build time of the 3D object. Additionally, if a component to be placed in the 3D object includes a dimension which is larger than a thickness of a layer of the successive layers deposited during the 3D print job, the component can interfere with components of the 3D printer, such as a build material distribution component (e.g., a roller to distribute build material), when a subsequent layer is deposited during the 3D print job.

Further, manual placement of components may not result in proper placement accuracy of the components in the 3D object. Additionally, components placed in the 3D object may not be properly thermally prepared, or, if thermally prepared, may not be manually placed quickly enough, which can cause losses in dimensional accuracy of the component and/or the 3D object, and/or warping of the placed component and/or warping of the 3D object being printed during the 3D print job.

Modules of 3D printers can allow for automated placement of components in a 3D object during a 3D print job. Components may include electrical components, optical components, mechanical components, aesthetic components, and/or any other components which can be placed in a 3D object during a 3D print job. The components can be placed and/or embedded in the 3D object during the 3D print job without placement accuracy issues, without reduction in dimensional accuracy of the components, and/or without warping of the placed components and/or warping of the 3D object. Additionally, the components can be placed and/or embedded in the 3D object during the 3D print job of the 3D objection without substantial delay in the 3D print job and/or without interference with components of the 3D printer during the 3D print job. Accordingly, modules of 3D printers can allow for a wide variety of 3D objects/devices to be created during a 3D print job.

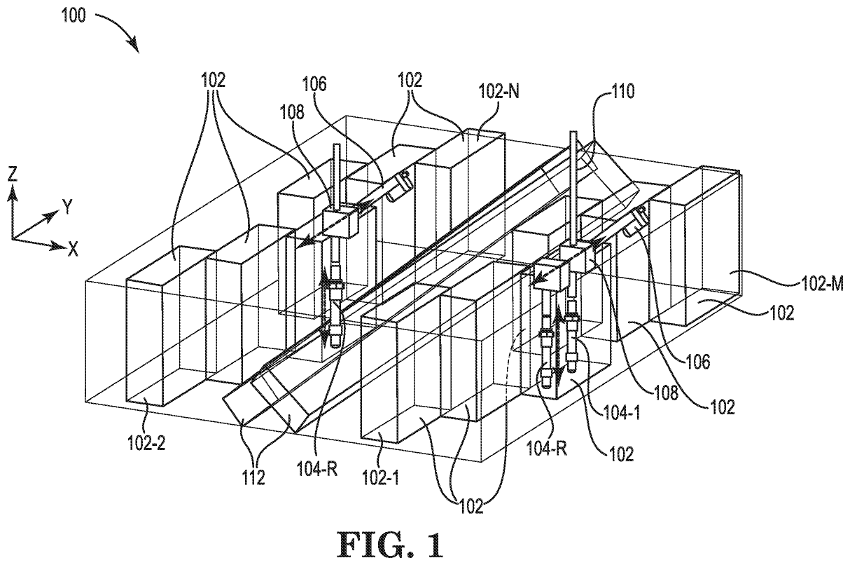

FIG. 1 illustrates a perspective view of an example of an interaction module 100 of a 3D printer consistent with the disclosure. The interaction module 100 may include an interaction sub-modules 102 and analytics system 112. Each interaction sub-module 102 can include couplers 104. Each coupler 104 can be connected to actuators 106, 108, and can include a coupler input 110.

As illustrated in FIG. 1, the perspective view of interaction module 100 can be oriented in an X-Y-Z coordinate plane. For example, the X-coordinate as shown in FIG. 1 can be a length, the Y-coordinate can be a width, and the Z-coordinate can be a height.

As illustrated in FIG. 1, interaction module 100 can include a plurality of interaction sub-modules 102. As used herein, the term “module” refers to a component of a 3D printing system. As used herein, the term “sub-module” refers to a component of a module, where the module is a component of a 3D printing system. For example, interaction module 100 can be a component of a 3D printer, and an interaction sub-module 102 can be a component of the interaction module 100, as is further described herein.

As illustrated in FIG. 1, interaction module 100 can include a plurality of interaction sub-modules 102. As used herein, the term “interaction sub-module” refers to a component of interaction module 100 that facilitates inputs to connect with tools to interact with a 3D object in a 3D printer during a 3D print job. For example, interaction sub-modules 102 can include inputs to couplers that connect with tools that interact with the 3D object, as is further described herein.

The interaction sub-modules 102 can be spaced apart across a width of interaction module 100. The interaction sub-modules 102 can be spaced apart to cover a particular swath of a build platform of a 3D printer. As used herein, the term “swath” refers to a space, such as a strip of area, covered by the movement of a portion of a device. For example, an interaction sub-module 102-1 can cover a particular swath of the build platform of the 3D printer as interaction sub-module 102 is moved across the build platform of the 3D printer.

Interaction sub-modules 102 can be spaced apart such that the width of each of the interaction sub-modules 102, taken together, can cover the entire width of the build platform as the interaction sub-modules 102 are moved across the build platform of the 3D printer. For example, as is further described herein, interaction sub-modules 102 can include couplers 104 that can be connected to various types of tools to interact with the 3D object during the 3D print job. Spacing apart interaction sub-modules 102 across the width of interaction module 100 can minimize a linear distance that any one tool connected to any one coupler 104 has to travel to interact with the 3D object. This can reduce an amount of time taken to interact with the 3D object by a particular tool(s), reducing the chance interaction with the 3D object may interfere with the build process, preventing delays to maintain high speed build processes.

The interaction sub-modules 102 can be located on opposing ends of the length of interaction module 100 and can cover corresponding swaths of the build platform. For example, as is further described herein, couplers of the interaction sub-modules 102 can connect with tools to interact with a 3D object being printed during a 3D print job.

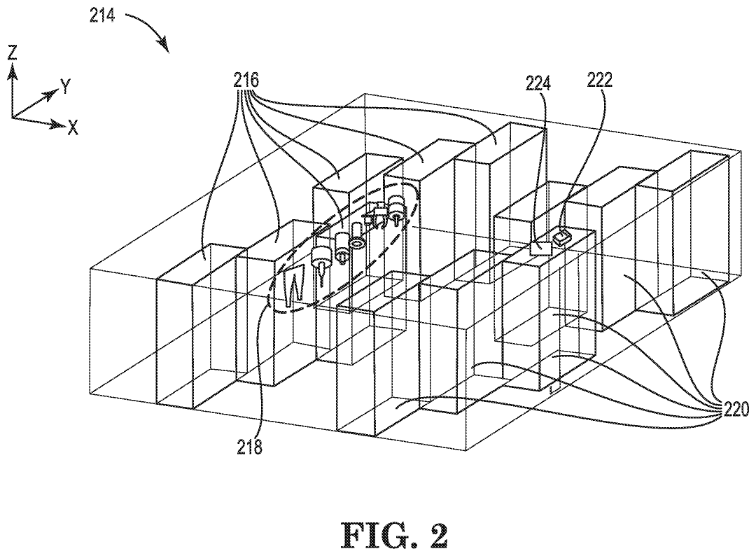

In some examples, opposing interaction sub modules 102, such as interaction sub module 102-1 and 102-2 can each be connected with tools (e.g., the same tools or different tools) and can cover a same swath of the build platform of the 3D printer such that, as interaction sub-modules 102-1 and 102-2 are moved over the swath of the build platform of the 3D printer, the interaction sub-modules 102-1 and 102-2 can maximize interaction with the 3D object in order to decrease the build time of the 3D object (e.g., can perform a particular interaction twice, can perform two separate interactions with different tools at a same or similar time, etc.) The couplers and corresponding coupled tools of each of the interaction sub-modules 102 can be moved in a linear direction or in a rotational direction such that the couplers and corresponding coupled tools of a particular interaction sub-module 102 can cover an entire swath which the corresponding interaction sub-module 102 is set to cover and can reach each tool included in a corresponding interaction preparation module, as is further described in connection with FIG. 2.

In some examples, interaction sub-modules can be offset from each other in the X-direction. For example, as illustrated in FIG. 1, interaction sub-modules 102-1 through 102-M (e.g., the interaction sub-modules located on the right side of interaction module 100 as oriented in FIG. 1) can be offset from each other in the X-direction such that each coupler(s) within each interaction sub-module 102 can access an entire swath which the corresponding interaction sub-module 102 is set to cover and can reach each tool included in a corresponding interaction preparation module, as is further described in connection with FIG. 2.

Additionally, although interaction sub-modules 102-1 and 102-2 are described as being located on opposing ends and covering corresponding swaths of the build platform, examples of the disclosure are not limited to merely interaction sub-modules 102-1 and 102-2 covering corresponding swaths. For example, interaction sub-modules 102 on the opposing ends of interaction module 100 can cover corresponding swaths of the build platform generally, such as interaction sub-modules 102-M and 102-N.

Although interaction module 100 includes a plurality of individual interaction sub modules 102, discussion herein of the plurality of interaction sub-modules 102 is generalized to interaction sub-module 102. However, the general discussion of interaction sub-module 102 herein can apply to each of the plurality of interaction sub-modules 102 of interaction module 100.

Interaction sub-module 102 can include a coupler 104. As used herein, the term “coupler” refers to an implement to connect to a tool. For example, coupler 104 can connect with a tool such that the tool can interact with the 30 object being printed during a 3D print job, as is further described herein. As used herein, the term “tool” refers to an implement to perform mechanical operations. For example, coupler 104 can selectively engage with a particular tool that can selectively engage and/or selectively disengage from a part, among other types of tools and/or corresponding tool functionalities. As used herein, the term “engage” refers to securing a connection between two objects. As used herein, the term “disengage” refers to removing a connection between two objects.

Coupler 104 can include an input 110. As used herein, the term “input” refers to a force or material supplied to a coupler to allow a corresponding tool to utilize the energy or material to interact with a 3D object. For example, input 110 can be an input to coupler 104 to allow a tool connected to coupler 104 to interact with a 3D object being printed during a 3D print job. Examples of an input 110 can include a vacuum input, a gas input, a power input, and/or a solder paste input, among other types of inputs 110, as are further described herein.

Input 110 can be a vacuum input. As used herein, the term “vacuum” refers to a region with a pressure less than that of atmospheric pressure. The region with the pressure less than that of atmospheric pressure can cause a suction force. As used herein, the term “suction” refers to the production of a partial vacuum by the removal of an amount of air to cause an attraction force towards the space of the partial vacuum, Accordingly, as used herein, the term “vacuum input” refers to an input 110 to coupler 104 that can cause a tool connected to coupler 104 to cause a suction force such that the tool can selectively engage with (e.g., via the suction force) and/or selectively disengage from (e.g., by removing the suction force) with a component to be placed in a particular location corresponding to the 3D object being printed, as is further described herein.

Input 110 can be a gas input. As used herein, the term “gas input” refers to an input 110 to coupler 104 that can cause a tool connected to coupler 104 to direct a flow of gas at a particular location corresponding to the 3D object being printed. For example, a gas input can direct a flow of gas, such as air or other type of gas, at a particular location on the 3D object, as is further described herein.

Input 110 can be a mechanical input. As used herein, the term “mechanical input” refers to an input 110 to coupler 104 that can cause a mechanical force to be applied to the tool connected to coupler 104. For example, a mechanical input can be applied to an extruder tool to cause various material to be extruded from the extruder tool at a particular location on the 3D object, as is further described herein. The mechanical input can be actuated through an electrical input or through direct mechanical input.

Input 110 can be a power input. As used herein, the term “power input” refers to an input 110 to coupler 104 that can provide electrical power to a tool connected to coupler 104. The tool connected to coupler 104 can utilize the electrical power in order to interact with the 3D object, as is further described herein.

Input 110 can be a solder paste input. As used herein, the term “solder paste” refers to a conductive material to electrically connect electrical components and/or mechanically bond components to an object. For example, solder paste can be utilized to electrically connect components in the 3D object being printed in the 3D print job, among other examples. Accordingly, as used herein, the term “solder paste input” refers to an input 110 to coupler 104 that can cause a tool connected to coupler 104 to apply solder paste to the 3D object, as is further described herein.

Although input 110 is described above as being a solder paste input, examples of the disclosure are not so limited. For example, the input 110 can be an absorbing material input, an anti-coalescent material input, and/or a conductive ink/paint input, among other types of materials that can be applied to the 3D object.

Although input 110 is described above as including a vacuum input, gas input, mechanical input, power input, and/or solder paste input, examples of the disclosure are not so limited. For example, input 110 can include any other type of input to allow a tool connected to coupler 104 to interact with a 3D object during a 3D print job.

As described above, coupler 104 can connect to a tool such that the tool can interact with a 3D object. The interaction of the tool with the 3D object can be based on a type of tool connected to the coupler. That is, the tool can interact with the 3D object in various different ways based on the type of tool. Examples of tools can include vacuum cups, vacuum nozzles, grippers, vacuum needles, blades, extruders, probe tweezers, lasers, among other types of tools, as are further described herein and with respect to FIG. 2.

Tools can include vacuum cups. As used herein, the term “vacuum cup” refers to a mechanical device shaped in a hemispherical, conical, or other shape to control a flow of gas to selectively engage with and/or selectively disengage from an object via a vacuum. For example, a vacuum cup can utilize a vacuum input 110 to cause a suction force such that the vacuum cup can selectively engage with and/or selectively disengage from a component (e.g., by removing the suction force). In some examples, the tool can include more than one input. For example, the vacuum cup can include a vacuum input 110 to cause the suction force to selectively engage with the component, the vacuum input 110 can be turned off to remove the suction force, and the input can be changed to an gas input 110 to provide a slight positive pressure to selectively disengage from the component.

Vacuum cups can selectively engage with and/or selectively disengage from a component. Vacuum cups may be differently sized based on a size of a component to engage/disengage. Vacuum cups may be of a flexible material to allow for better engagement.

Tools can include vacuum nozzles. As used herein, the term “vacuum nozzle” refers to a mechanical device shaped as a cylindrical spout to control a flow of gas to selectively engage with and/or selectively disengage from an object via a vacuum. For example, a vacuum nozzle can utilize a vacuum input 110 to cause a suction force such that the vacuum nozzle can selectively engage with and/or selectively disengage from a component (e,g., by removing the suction force).

Tools can include grippers. As used herein, the term “gripper” refers to a mechanical device to enable the selective engagement of an object and/or selective disengagement from the object. For example, a gripper can utilize an electrical input 110 to cause a mechanical grip to selectively engage with a component and/or selectively disengage from the component. Grippers may be utilized to engage/disengage a component which may not have a flat top. Grippers can engage a component utilizing friction (e.g., friction prevents the component from disengaging from the grippers when the grippers engage the component). For example, a component which may not have a flat top may not be suitable for engaging with a vacuum cup or a vacuum nozzle. Accordingly, grippers may be used to engage/disengage the component.

Tools can include vacuum needles. As used herein, the term “vacuum needle” refers to a slender rod-like device to control a flow of gas to remove material from an object. For example, a vacuum needle can utilize a vacuum input 110 to cause a suction force in order to remove material, such as build material, from a 3D object.

In some examples, vacuum needles can include a slanted or tapered end. In some examples, the slanted or tapered end can be sharpened. The sharpened slanted or tapered end can allow the vacuum needle to more easily/effectively move through build material of the 3D object, as the build material may be partially fused in some examples. The sharpened slanted or tapered end can allow the vacuum needle to disrupt build material of the 3D object intended to be removed from the 3D object. Further, utilizing the vacuum input 110 to the vacuum needle with a slanted/tapered end can allow for simultaneous removal of build material from the 3D object as the vacuum needle is moved around an area of the 3D object where removal of build material is intended.

Tools can include blades. As used herein, the term “blade” refers to a thin, flat piece of material. For example, the blade can clear, wipe, scrape, or otherwise disturb portions of the 3D object.

Tools can include an extruder. As used herein, the term “extruder” refers to a device to press or otherwise force a material from a container. An extruder can utilize a gas input 110 to actuate extrusion of the material from the container. For example, the gas input 110 of coupler 104 can cause an actuation force to press or otherwise force material from the container it is located in.

In some examples, an extruder can include a solder paste extruder. The solder paste extruder can cause solder paste to be applied to the 3D object. The solder paste can be applied to the 3D object to ensure proper electronic connections of components of the 3D object, fill gaps between placed components in the 3D object and conductive part portions, etc. However, examples of the disclosure are not limited to solder paste extruders. For example, an extruder can include an absorbing material extruder, an anti-coalescent material extruder, and/or a conductive ink/paint extruder (e.g., silver paste, ink, etc.), among other types of extruders to extrude other types of materials to be applied to a 3D object during a 3D print job.

The extruder in some examples can extrude a conductive ink to be deposited in select areas of the 3D object which are desired to become conductive within the 3D object. In some examples, the ink can be non-conductive when applied but can become conductive in a later process, such as after the 3D print job is completed or during a follow up post-process. For example, the non-conductive ink can become conductive as a result of application of heat during the 3D print job or after the 3D print job (e.g., through a post-printing thermal treatment step).

Tools can include probe tweezers. As used herein, the term “probe tweezers” refers to electrical contacts to measure electrical properties of an electrical device. Probe tweezers can utilize a power input 110 to measure voltage, current, and/or resistance of an electrical component in a 3D object. For example, probe tweezers can be put in contact with placed components, printed traces, and/or extruded conductive material (e.g., extruded solder paste) for doing in-situ resistance testing and/or performing other electrical testing during the 3D print job. Probe tweezers can improve testing and reliability of the 3D object, especially in circumstances where components are embedded within a 3D object that may not be able to be tested after the 3D print job is finished.

Tools can include lasers. As used herein, the term “laser” refers to a device that emits light coherently, spatially, and temporally. For example, a laser can utilize a power input 110 to focus a beam of light to an area or point on the 3D object.

The laser can apply thermal energy to portions of the 3D object while integrating electronic components in the 3D object. For example, a solder paste may be applied to the 3D object which may have to reach an elevated temperature for solder flow and/or activating a solder flux. Lasers can apply thermal energy such that the applied solder paste can reach the appropriate temperatures. In some examples, absorbing agents may be placed in areas which have to reach the elevated temperature, which can enhance laser light absorption.

Although the tools described above include vacuum cups, vacuum nozzles, grippers, vacuum needles, blades, extruders, probe tweezers, and/or lasers, examples of the disclosure are not so limited. For example, coupler 104 can connect with any other type of tool in order to interact with a 3D object during a 3D print job.

The tools described above can be located in an interaction preparation module. For example, coupler 104 can connect to a tool located in the interaction preparation module, and then utilize the tool to interact with a 3D object during a 3D print job, as is further described herein. The interaction preparation module is further described in connection with FIG. 2.

Although interaction sub-module 102 is described as including one coupler 104, examples of the disclosure are not so limited. For example, as illustrated in FIG. 1, interaction sub-module 102 can include more than one coupler 104 (e.g., coupler 104-1, coupler 104-R). The couplers 104 can each be connected with a tool from a corresponding tool selection module of the interaction preparation module, further described in connection with FIG. 2. For example, couplers 104 can be connected with the same type of tool, with different tools, etc.

Interaction sub-module 102 can include a movement mechanism. As used herein, the term “movement mechanism” refers to a mechanism to move a component. For example, interaction sub-module 102 can include a movement mechanism to move a coupler in a particular direction. In some examples, the movement mechanism can be an actuator, as is further described herein. However, examples of the disclosure are not so limited. For example, the movement mechanism can be any other mechanism to move a coupler in a particular direction.

Interaction sub-module 102 can include an actuator 106, 108. As used herein, the term “actuator” refers to a component of a machine to move and/or control a mechanism. For example, interaction sub-module 102 can include an actuator 106, 108 to move coupler 104. Actuator 106, 108 can move coupler 104 such that a tool connected to coupler 104 can interact with the 3D object during the 3D print job. Actuators 106, 108 can be linear actuators, rotational actuators, etc.

Actuator 106, 108 can be a linear actuator. As used herein, the term “linear actuator” refers to a component of a machine to move and/or control a mechanism in a linear direction. For example, actuator 106, 108 can move coupler 104 (e.g., and a tool, if connected to coupler 104) in a linear direction.

Actuator 106, 108 can move coupler 104 in a particular linear direction via different mechanisms. For example, actuator 106, 108 can be a mechanical actuator such as a screw, belt driven, wheel and axle, rack-and-pinion, and/or cam mechanical actuator, hydraulic actuator, pneumatic actuator, piezoelectric actuator, linear motor actuator, electro-mechanical actuator, among other types of linear actuators.

Actuator 106 can move coupler 104 in a first direction. For example, actuator 106 can move coupler 104 in a direction along a width of interaction module 100. That is, actuator 106 can move coupler 104 in a Y-direction. Actuator 106 can be a belt driven linear actuator. However, examples of the disclosure are not limited to a belt driven linear actuator. For example, actuator 106 can be any other linear actuator. For example, the type of actuator may depend on space constraints of interaction module 100. As described above, in some examples, the interaction sub-module 102 including coupler 104 can define a swath of the build platform that coupler 104 can cover. For example, linear actuator 106 can move coupler 104 linearly in the Y-direction a distance of the width of interaction sub-module 102, where the distance of the width of interaction sub-module 102 is the swath of the build platform that coupler 104 can cover. In other words, as the interaction sub-modules 102 is moved over the build platform of the 3D printer, coupler 104 (and the tool coupled to coupler 104) can interact with the portion of the 3D object located in the swath corresponding to the distance of the width of the interaction sub-module 102 by linearly moving coupler 104 (and the tool coupled to coupler 104) by linear actuator 106 within the distance of the width of the interaction sub-module 102.

Actuator 108 can move coupler 104 in a second direction. For example, actuator 108 can move coupler 104 in a direction along a height of interaction module 100. That is, actuator 108 can move coupler 104 in a Z-direction. Actuator 108 can be an electro-mechanical actuator. However, examples of the disclosure are not limited to an electro-mechanical linear actuator. For example, actuator 108 can be any other linear actuator.

In some examples, actuator 106, 108 can be a rotational actuator. As used herein, the term “rotational actuator” refers to a component of a machine to move and/or control a mechanism in a rotational direction. For example, actuator 106, 108 can move coupler 104 (e.g., and a tool, if connected to coupler 104) in a rotational direction.

In an example in which actuator 106 is a rotational actuator, rotational actuator 106 can move coupler 104 in a first direction where the first direction is a rotational direction. For example, actuator 106 can move coupler 104 in a rotational direction, where the width of interaction sub-module 102 corresponds to the diameter of rotational movement. As described above, in some examples, the interaction sub-module 102 including coupler 104 can define a swath of the build platform that coupler 104 can cover. For example, rotational actuator 106 can move coupler 104 in a rotational direction, where the diameter of rotational movement corresponds to a distance of the width of interaction sub-module 102, where the distance of the width of interaction sub-module 102 is the swath of the build platform that coupler 104 can cover. In other words, as the interaction sub-modules 102 is moved over the build platform of the 3D printer, coupler 104 (and the tool coupled to coupler 104) can interact with the portion of the 3D object located in the swath corresponding to the distance of the width of the interaction sub-module 102 by rotating coupler 104 (and the tool coupled to coupler 104) by rotational actuator 106 within the distance of the width of the interaction sub-module 102.

The tool connected to coupler 104 can interact with the 3D object of the 3D printer during a 3D print job. As used herein, the term “interact” refers to acting upon the 3D object via a tool. For example, interaction with the 3D object can include placing components at a location corresponding to the 3D object, removing build material from a particular location corresponding to the 3D object, applying material such as conductive material, absorbing material, anti-coalescent material, among other types of materials to the 3D object, applying energy, such as thermal energy, to the 3D object, and/or performance and/or reliability testing of the 3D object and/or components of the 3D object, among other types of interactions with the 3D object.

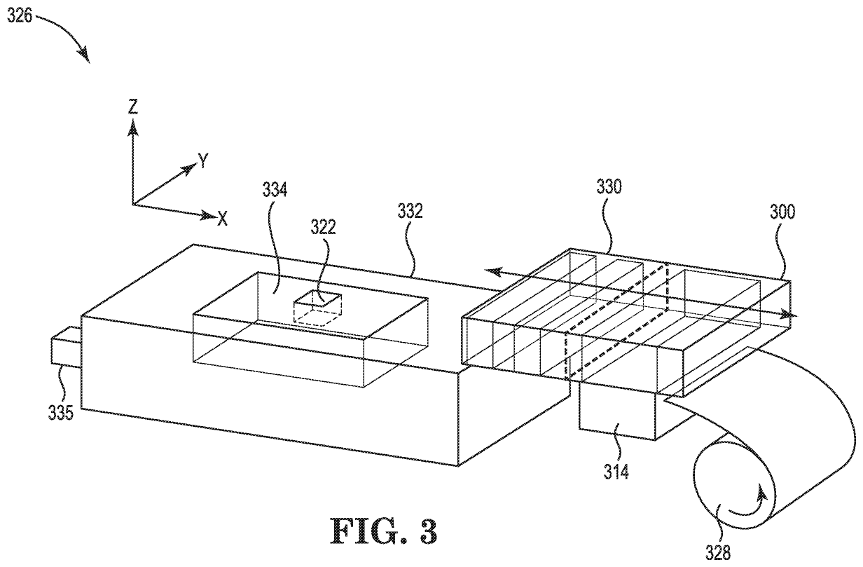

In order for a tool to interact with the 3D object, coupler 104 has to be connected with the tool. For example, actuator 106 can move coupler 104 in the Y-direction to a particular position defined by an X-coordinate, Y-coordinate, and Z-coordinate, where the particular position can be the position of a particular tool to be used to interact with the 3D object. Coupler 104 can be moved in the X-direction by interaction module 100 to the particular position. That is, movement of coupler 104 in the X-direction is controlled by movement of interaction module 100. Interaction module 100 can be controlled in the X-direction by a linear actuator (e.g., not illustrated in FIG. 1 for clarity and so as not to obscure examples of the disclosure), or interaction module 100 can be connected to a build material carriage such that interaction module 100 can be controlled in the X-direction by the build material carriage, as is further described in connection with FIG. 3.

Once coupler 104 is in the particular position (e.g., at the correct X and Y-coordinates), coupler 104 can be moved in the Z-direction by actuator 108. Movement in the Z-direction can move coupler 104 towards a particular tool (e.g., stored in the interaction preparation module, described in further detail in connection with FIG. 2) so that coupler 104 can connect with a tool.

Coupler 104 can connect with the tool using different mechanisms. For example, coupler 104 can connect with the tool using a mechanical latch or fastener, pneumatics, vacuum, magnetic coupling, and/or interference (e.g., friction) fit, among other types of attachment mechanisms.

Once coupler 104 is connected with the tool, coupler 104 can be moved in the Z-direction to clear the interaction preparation module. Coupler 104 can be moved to a particular location in the build platform of the 3D printer defined by X, Y, and Z-coordinates. Coupler 104 can be moved the to the particular location in the build platform by actuators 106, 108, and either an actuator controlling interaction module 100 or by a build material carriage.

In some examples, the tool connected to coupler 104 can interact with the 3D object by selectively engaging a component and selectively disengaging from the component to place the component at a placement location corresponding to the 3D object. The placement location can correspond to the particular location described above (e.g., the particular location in the build platform of the 3D printer defined by X, Y, and Z-coordinates).

The tool may be a vacuum cup, a vacuum nozzle, or a gripper. For instance, if the tool is a vacuum cup or a vacuum nozzle, input 110 can be a vacuum input such that the vacuum cup or vacuum nozzle can selectively engage with the component. If the tool is a gripper, input 110 can be an electrical input such that the gripper can selectively engage with the component. The tool can selectively engage with the component at a component pickup platform of the interaction preparation module, as is further described in connection with FIG. 2.

The tool connected to coupler 104 can be moved to the placement location corresponding to the 3D object. That is, the tool connected to coupler 104 can be moved to a location at which the component is to be placed in or on the 3D object. The tool can selectively disengage from the component at the placement location in order to place the component. In some examples, selectively disengaging from the component can include removing the suction force of the vacuum cup or the vacuum nozzle. In some examples, selectively disengaging from the component can include releasing the mechanical grip of a gripper. In some examples, selectively disengaging from the component can include providing, by input 110, a short pulse of gas (e.g., a short pulse of positive air pressure) to selectively disengage the component from the tool.

Components placed in or on the 3D object can include electrical components. For example, an electrical component can include a resistor, capacitor, transistor, antenna, radio frequency identification (RFID) chip, integrated circuit, power adaptor, battery, battery connector, through-hole electronic components, solder paste, vias, conductive wires, switches, connectors, universal serial bus (USB) ports, any other electrical components including circuit components and/or connections thereof, and/or any combination of electrical components thereof, among other types of electrical components.

Components placed in or on the 3D object can include optical components. For example, an optical component can include a lens, filter, mirror, grating, fiber optic cable, transparent, semi-transparent, or translucent film or window, and/or any combination thereof, among other types of optical components.

Components placed in or on the 3D object can include mechanical components. For example, a mechanical component can include a wire, wire mesh, gear, axle, cam, carbon fiber sheet, and/or any combination thereof, among other types of mechanical components.

Components placed in or on the 3D object can include aesthetic components. For example, an aesthetic component can include a gem, polished metal, decorative element, etc.

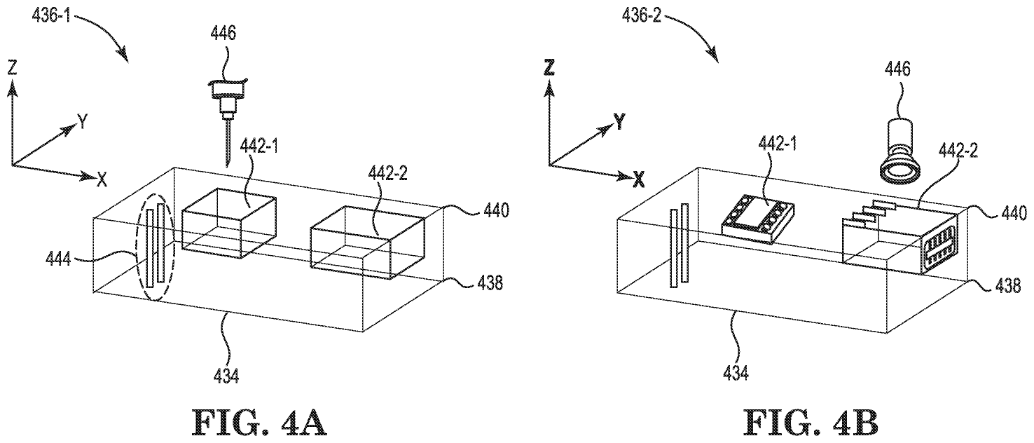

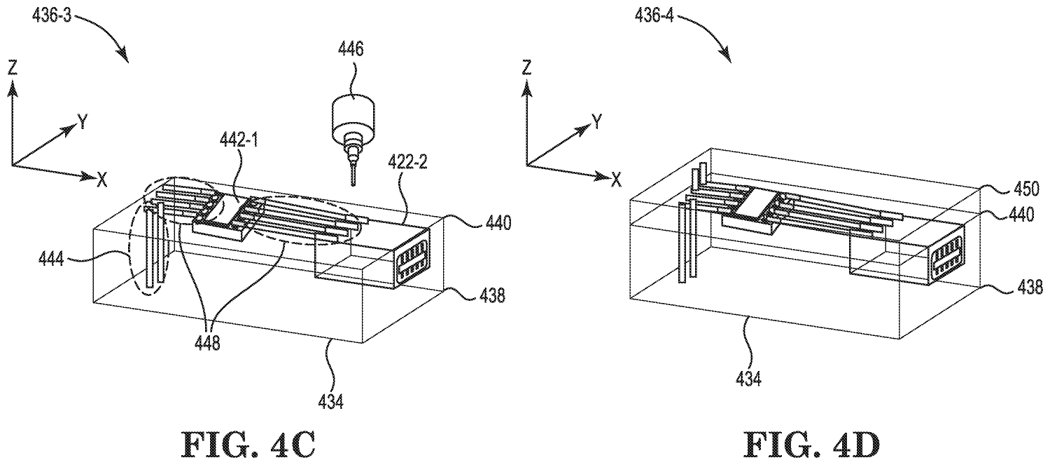

Although components are described above as being an electrical component, optical component, mechanical component, and/or an aesthetic component, as well as examples thereof, examples of the disclosure are not so limited. For example, components can be any other type of component to be placed in a 3D object during a 3D print job. For instance, a customer of the 3D object being created may request a particular component or components be included in the 3D object during the 3D print job, and the component(s) can be placed in the 3D object during the 3D print job, as is further described in connection with FIGS. 3 and 4A-4D.

In some examples, the tool connected to coupler 104 can interact with the 3D object by removing build material from a particular location of the 3D object. The particular location can correspond to a location in the build platform of the 3D printer defined by X, Y, and Z-coordinates.

The tool may be a vacuum needle. For example, the vacuum needle can be connected to coupler 104, and a vacuum input 110 can be connected to coupler 104. The vacuum needle may utilize the suction force created by vacuum input 110 to remove material from the 3D object. For example, an anti-coalescent agent may be applied to build material at the particular location on the 3D object such that the build material at the particular location does not fuse. The vacuum needle may remove the non-fused build material from the particular portion of the 3D object utilizing the suction force created by vacuum input 110. Removing the non-fused build material can create a cavity where a component may be placed, as is further described in connection with FIGS. 4A-4D.

In some examples, the tool connected to coupler 104 can interact with the 3D object by applying material to the 3D object at a particular location of the 3D object. The particular location can correspond to a location in the build platform of the 3D printer defined by X, Y, and Z-coordinates.

The tool may be an extruder. For example, the extruder can be connected to coupler 104, and a gas input 110 or a mechanical input 110 can be connected to coupler 104. The extruder may utilize a positive air pressure provided by gas input 110 or a mechanical force provided by mechanical input 110 to extrude various materials onto the 3D object, such as conductive material (e.g., solder paste), absorbing material, anti-coalescent material, etc.

In some examples, the tool connected to coupler 104 can interact with the 3D object by applying energy to the 3D object at a particular location of the 3D object. The particular location can correspond to a location in the build platform of the 3D printer defined by X, Y, and Z-coordinates.

The tool may be a laser. For example, the laser can be connected to coupler 104, and a power input 110 may be connected to coupler 104. The laser may utilize electrical power provided by power input 110 to direct energy, such as thermal energy, to the 3D object at the particular location of the 3D object. The laser can provide thermal energy to raise temperatures of components of the 3D object, among other examples.

In some examples, the tool connected to coupler 104 can interact with the 3D object by performing reliability and/or performance testing of the 3D object at a particular location of the 3D object. The particular location can correspond to a location in the build platform of the 3D printer defined by X, Y, and Z-coordinates.

The tool may be probe tweezers. The probe tweezers may utilize electrical power provided by power input 110 to applying probe tweezers to the 3D object, a component of the 3D object, and/or electrical connections between components of the 3D object in order to test electrical connections, resistances therebetween, voltages, and/or current characteristics of the component of the 3D object, and/or electrical connections between components of the 3D object for quality control, testing, reliability, etc.

As illustrated in FIG. 1, interaction module 100 includes an analytics system 112, As used herein, the term “analytics system” refers to a system to examine characteristics of the operations of the 3D printer. For example, analytics system 112 can analyze operations of interaction sub-modules 102 (e.g., movement of coupler 104, connections of coupler 104 with tools, engagement/disengagement with components by various tools connected to coupler 104, interactions with the 3D object, etc.)

As illustrated in FIG. 1, analytics system 112 can be oriented at an angle relative to interaction sub-modules 102. Analytics system 112 can be oriented at an angle so that analytics system 112 has a line of sight to the interaction sub-modules 102. As used herein, the term “line of sight” refers to an imagined straight line between two objects that is not obstructed by any objects therebetween. For example, analytics system 112 can be oriented at an angle so that there are no objects situated between analytics system 112 and interaction sub-modules 102.

Analytics system 112 can include various types of sensors to examine characteristics of the operations of the 3D printer, As used herein, the term “sensor” refers to a device to detect events or changes in an environment surrounding the sensor. For example, analytics system 112 can include various sensors to detect events or changes in an environment in and/or around the 3D printer, the interaction module 100, the interaction preparation module (e.g., described in connection with FIG. 2), etc.

In some examples, analytics system 112 can include a visual sensor to monitor interaction with the 3D object and/or component pickup process. As used herein, the term “visual sensor” refers to a sensor to detect events or changes in an environment utilizing optical instruments. For example, the visual sensor can include high speed cameras, thermal cameras, video cameras, etc. For example, visual sensors can monitor a status of component engagement (e.g., successful engagement, in progress engagement, failed engagement, eta), orientation of an engaged component, position, speed, accuracy, etc. of tools selectively engaging a component and selectively disengaging from the component, placement of the component at a placement location corresponding to the 3D object (e.g., correct/incorrect placement location on the 3D object, orientation in the 3D object, etc.), among other examples.

In some examples, analytics system 112 can include a temperature sensor to monitor interaction with the 3D object. As used herein, the term “temperature sensor” refers to a sensor to detect temperature related events or changes in an environment. For example, the temperature sensor can include an infrared (IR) sensor, laser profilometers, among other types of temperature sensors.

Analytics system 112 can assess whether there are any non-idealities which may occur during placement of components, removal of material from the 3D object, addition of material to the 3D object, errors in component selection/engagement such as wrong type of component, erroneous engagement/disengagement location, improper thermal characteristics (e.g., components are too hot/too cold, which may cause warping of components and/or of the 3D object), placement accuracy, geometry of added material (e.g., modification of geometry of solder paste/traces/connections to correct faulty electrical connections, etc.)

Although analytics system 112 is illustrated as being included in interaction module 100, examples of the disclosure are not so limited. For example, analytics system 112 may be located in the interaction preparation module and/or above the interaction preparation module (e.g., as described in connection with FIG. 2). Analytics system 112 may be utilized to analyzing component engagement, component orientation when engaged with a tool/coupler such as position and/or rotation of the component as engaged by the tool/coupler, build material removal from the 3D object or from the build platform of the 3D printer, component placement, and/or component orientation during placement, among other analyses.

FIG. 2 illustrates a perspective view of an example of an interaction preparation module 214 of a 3D printer consistent with the disclosure. Interaction preparation module 214 can include tool selection sub-modules 216 and component pickup platforms 220. Tool selection sub-modules 216 can include tools 218. Component pickup platforms 220 can include heaters 224.

As illustrated in FIG. 2, the perspective view of interaction preparation module 214 can be oriented in an X-Y-Z coordinate plane. For example, the X-coordinate as shown in FIG. 2 can be a length, the Y-coordinate can be a width, and the Z-coordinate can be a height.

As illustrated in FIG. 2, interaction preparation module 214 can include a plurality of tool selection sub-modules 216. As used herein, the term “tool selection sub-module” refers to a component of interaction preparation module 214 that facilitates connections of tools 218 with couplers included in interaction sub-modules of the interaction module, previously described in connection with FIG. 1. For example, each of the tool selection sub-modules 216 can include a plurality of tools 218, as is further described herein. The plurality of tools included in each of the tool selection sub-modules 216 can be the same plurality of tools, or different tools included in different ones of the tool selection sub-modules 216.

Tool selection sub-modules 216 can be spaced apart across a width of the interaction preparation module 214. Spacing apart the tool selection sub-modules across the width of interaction preparation module 214 can minimize a linear distance a coupler has to travel to connect to a tool included in tool selection sub-modules 216. This can reduce an amount of time taken to connect to a tool to allow the tool to interact with the 3D object, which can preventing delays and maintain high speed build processes of 3D objects.

Although interaction preparation module 214 includes a plurality of individual tool selection sub-modules 216, discussion herein of the plurality of tool selection sub-modules 216 is generalized to tool selection sub-module 216. However, the discussion of tool selection sub-module 216 generally herein can apply to each of the plurality of tool selection sub-modules 216.

As described above, tool selection sub-module 216 can include tools 218. Tools 218 can include vacuum cups, vacuum nozzles, grippers, vacuum needles, blades, extruders, probe tweezers, and/or lasers. However, examples of the disclosure are not so limited to the above listed tools. For example, tools 218 can include any other type of tool to interact with a 3D object during a 3D print job.

A tool of tools 218 can be connected to a coupler. For example, a coupler included in an interaction sub-module (e,g., an interaction sub-module 102, previously described in connection with FIG. 1) can be moved such that the coupler can connect to a particular tool. For example, a coupler can be connected to a vacuum cup included in tools 218, among other examples of tools. Once the vacuum cup is connected to the coupler, the vacuum cup can interact with the 3D object of the 3D printer during a 3D print job, as is further described herein.

Interaction preparation module 214 can include component pickup platforms 220. As used herein, the term “component pickup platform” refers to an area at which components 222 can be provided for selective engagement by a tool 218. Continuing with the example above, a tool such as a vacuum cup can be connected to a coupler, and the coupler can include a vacuum input such that the vacuum cup can selectively engage component 222, such as an integrated circuit, from a particular component pickup platform 220. The component 222 can be placed at a placement location corresponding to the 3D object once selectively engaged by the vacuum cup.

Interaction preparation module 214 can include heater 224. As used herein, the term “heater” refers to a device that generates thermal radiation. For example, heater 224 can generate thermal radiation to cause components 222 provided to interaction preparation module 214 to be heated if the components 222 provided to interaction preparation module 214 are at a temperature that is less than the temperature of the heater 224.

Heater 224 can be utilized to thermally prepare components 222 for placement at the particular location corresponding to the 3D object. Heater 224 can be utilized to thermally prepare components 222 for placement in order to reduce the chance that losses in dimensional accuracy of the component 222 and/or the 3D object, and/or warping of the placed component 222 and/or warping of the 3D object being printed during the 3D print job occurs as a result of improper thermal preparation of the components 222. For example, when components 222 are placed in the 3D object, they may have to be heated near the temperature of the build material (e.g., between the polymer melting temperature and the recrystallization temperature of the build material) in order to avoid component 222 or 3D object warping. In some examples, components 222 may be heated slightly above the temperature of the build material or the melting temperature of the build material in order to re-melt and/or re-flow build material around a placed component and/or to sinter some conductive material placed around the component.

As illustrated in FIG. 2, heater 224 can be included on the component pickup platform 220. For example, as components 222 are delivered to the interaction preparation module 214 (e.g., and to component pickup platform 220), components 222 may be heated by heater 224.

Although heater 224 is described above and illustrated in FIG. 2 as being included on the component pickup platform 220, examples of the disclosure are not so limited. For example, heater 224 can be at a location in interaction preparation module 214 to heat components 222 as they are provided to interaction preparation module 214 that is not on component pickup platform 220. For instance, heater 224 may be located proximate to the component pickup platform 220.

Sizes of heaters 224 and/or placement locations of heaters 224 may be selected based on various factors. For example, a large component 222 may have to undergo a longer heating period to reach a sufficient (e.g., threshold) temperature than a smaller component 222. In some examples, components 222 may be overheated (e.g., beyond the threshold temperature) to provide for more facile placement of components 222.

FIG. 3 illustrates a perspective view of an example of a system 326 consistent with the disclosure. The system 326 can include controller 335, interaction module 300, interaction preparation module 314, component reel module 328, build material carriage 330, and build platform 332. Build platform 332 can include 3D object 334. 3D object 334 can include component 322.

As illustrated in FIG. 3, the perspective view of the system 326 can be oriented in an X-Y-Z coordinate plane. For example, the X-coordinate as shown in FIG. 3 can be a length, the Y-coordinate can be a width, and the Z-coordinate can be a height.

System 326 can be a 3D printer. For example, system 326 can be a multi-jet fusion printer, among other types of 3D printers. The 3D printer of system 326 can deposit build material and a fusing agent in successive layers, and the build material can be fused by a lamp and the fusing agent to create 3D object 334. Part 308 can be placed in 3D object 334, as is further described herein.

In some examples, the 3D printer can include a build platform 332. As used herein, the term “build platform” refers to a build location of the 3D printer, such as a powder bed. For example, the 3D printer may deposit build material and a fusing agent in successive layers in build platform 332, and the build material can be fused by a lamp and the fusing agent to create 3D object 334 in build platform 332. The build platform 332 can be included with the 3D printer or can be a separable connectable build platform.

As used herein, the term “build material” can refer to a material used to create 3D objects in the 3D printer. Build material can be, for example, a powdered semi-crystalline thermoplastic material, a powdered metal material, a powdered plastic material, a powdered composite material, a powdered ceramic material, a powdered glass material, a powdered resin material, and/or a powdered polymer material, among other types of powdered or particulate material.

The 3D printer can include build material carriage 330. As used herein, the term “build material carriage” refers to a device that can include lamps to fuse the build material and/or inkjet printheads. For example, build material carriage 330 can cause build material to be fused to create 3D object 334. In some examples, build material carriage 330 can include build material to deposit to build platform 332. In some examples, build material carriage 330 can include a roller to spread build material in build platform 332.

As previously described in connection with FIG. 2, system 326 can include interaction preparation module 314. Although not illustrated in FIG. 3 for clarity and so as not to obscure examples of the disclosure, interaction preparation module 314 can include a plurality of tool selection sub-modules. Each of the plurality of tool selection sub-modules can be spaced apart to cover a particular swath of the build platform 332. For example, each of the plurality of tool selection sub-modules can correspond to a particular interaction sub-module included in interaction module 300 in order to minimize a distance a coupler of an interaction sub-module has to travel to connect to a tool included in corresponding tool selection sub-module. This can reduce an amount of time taken to connect a coupler to a tool to allow the tool to interact with 3D object 334, which can prevent delays and maintain a high-speed build process of 3D object 334.

Each of the tool selection sub-modules of interaction preparation module 314 can include a plurality of tools. For example, each of the tool selection sub-modules can include vacuum cups, vacuum nozzles, grippers, vacuum needles, blades, extruders, probe tweezers, lasers, among other types of tools.

As previously described in connection with FIG. 1, system 326 can include interaction module 300. Although not illustrated in FIG. 1 for clarity and so as not to obscure examples of the disclosure, interaction module 300 can include a plurality of interaction sub-modules. Each of the plurality of interaction sub-modules can be spaced apart to cover a particular swath of the build platform 332. Spacing apart the interaction sub-modules across the width of interaction module 300 can minimize a linear distance that any one tool connected to any one coupler has to travel to interact with 3D object 334. This can reduce an amount of time taken to interact with 3D object 334 by a particular tool(s), reducing the chance interaction with 3D object 334 by the tool may interfere with the build process, preventing delays and to maintain a high speed build process for 3D object 334.

The interaction sub-module of interaction module 300 can include a coupler. For example, the coupler can connect with a tool located in the tool selection sub-module of interaction preparation module 314 such that the tool can interact with the 3D object 334 being printed during the 3D print job.

For example, controller 335 of system 326 can cause interaction module 300 to be located in the position as illustrated in FIG. 3. Further, controller 335 can cause a coupler of an interaction sub-module of interaction module 300 to move to a predetermined location of a particular tool (defined by X, Y, and Z coordinates) via various actuators. Once the coupler is at the predetermined location of the particular tool, controller 335 can cause the coupler to connect to the tool (e.g., by causing the coupler to move in the Z-direction to connect to the tool in the tool selection sub-module of interaction preparation module 314).

As described above, interaction module 300 can be moved in an X-direction. In some examples, interaction module 300 can be moved in the X-direction via an actuator (e.g., not illustrated in FIG. 3). In an example in which interaction module 300 is moved in the X-direction via an actuator, interaction module 300 can interact with 3D object 334 independently of the movement of build material carriage 330. This can allow for interaction with the 3D object 334 without relying on the movement of build material carriage 330, which may allow for multiple interactions with 3D object 334 in a single pass of interaction module 300 over 3D object 334.

In some examples, interaction module 300 can be moved in an X-direction via build material carriage 330 (e.g., interaction module 300 can be connected to build material carriage 330). In such an example, interaction module 300 does not have to be moved by an additional actuator since interaction module 300 is connected to build material carriage 330. This can allow for faster build times of the 3D object as the movement of interaction module 300 is optimized and streamlined with the movement of build material carriage 330.

As illustrated in FIG. 3, system 326 can include a component reel module 328. As used herein, the term “component reel module” refers to a tape including individual cavities, where the tape is wound around a reel. For example, component reel module 328 can include individual cavities which can include components to be placed in or on 3D object 334. As described above, the tape of component reel module 328 can include individual cavities, in which components may be placed. When the components are placed in the cavities of the tape of component reel module 328, the tape can be wound around a reel. Component reel module 328 may be included as part of the 3D printer or may be a separable and connectable component to the 3D printer.

As described above, the tape of component reel module 328 may include components to be placed in or on 3D object 334. As the tape is wound around a reel, the tape can be un-wound by rotation of the reel. For example, as illustrated in FIG. 3, component reel module can be rotated to cause the tape of component reel module 328 to provide a component to interaction preparation module 314.

In some examples, system 326 can utilize a component tray. As used herein, the term “component tray” refers to a flat shallow receptacle to hold a component. For example, a component tray may be used for components which may be too large for use in a component reel. The component tray can include a component and may be moved in to interaction preparation module 314 from an external location.

In some examples, system 326 can utilize a conveyor, As used herein, the term “conveyor” refers to a mechanical system that carries objects from one location to another location. For example, the conveyor can transport components that may be actively being placed in interaction preparation module 314. The conveyor may transport components, such as integrated chips, from a diced wafer (e.g., a silicon wafer with lithographically defined electronic components on it), and transport the integrated chips to the interaction preparation module 314.

The component 322 can be provided to a component pickup platform of interaction preparation module 314. As previously described in connection with FIG. 2, interaction preparation module 314 can include a component pickup platform to receive a component 322 to be placed in or on 3D object 334.

The component 322 can be pre-heated by a heater of the interaction preparation module 314. For example, a heater can be utilized to pre-heat components to thermally prepare components for placement in order to reduce the chance that losses in dimensional accuracy of the component 322 and/or the 3D object 334, and/or warping of the placed component 322 and/or warping of the 3D object 334 being printed during the 3D print job occurs as a result of improper thermal preparation of the component 322. Component 322 can be pre-heated by a heater as it is being delivered via a component reel, a component tray, and/or by a conveyor.

Although system 326 is illustrated in FIG. 3 as including component reel module 328 and component reel module 328 is described above as providing components to interaction preparation module 314 to be placed in or on 3D object 334, examples of the disclosure are not so limited. For example, components may be placed manually in interaction preparation module 314 or by any other mechanism.

The coupler of interaction module 300 can be adjustable relative to build platform 332 in a first direction (e.g., the Y-direction), adjustable relative to build platform 332 in a second direction (e.g., the Z-direction), and/or adjustable relative to build platform 332 in a third direction (e.g., the X-direction) to allow a tool connected to the coupler to interact with 3D object 334. As previously described in connection with FIGS. 1 and 2, interaction module 300 can include a first linear actuator and a second linear actuator. The first linear actuator can adjust the coupler in the Y-direction and the second linear actuator can adjust the coupler in the Z-direction. The interaction module 300 can be adjusted in the X-direction by a third actuator or by build material carriage 330, as is further described herein.

As described above, a component 322 may be provided to interaction preparation module 314 which may be desired to be placed in 3D object 334. In such an example, a coupler of the interaction module 300 can connect with a tool from a tool selection sub-module of the interaction preparation module 314, where the tool can selectively engage with and/or selectively disengage from the component 322.

The tool can be a vacuum cup, vacuum nozzle, or a gripper. For example, the coupler can connect with a vacuum cup. Once the coupler is connected to the vacuum cup, the coupler can be moved to the component pickup platform of the interaction preparation module 314. The tool (e.g., the vacuum cup) can selectively engage the pre-heated component 322 (e.g., pre-heated by the heater included in interaction preparation module 314). For example, the vacuum cup can engage the component 322 by engaging a suction force created by an input to the coupler having the vacuum cup connected to it.

Once component 322 is engaged by the vacuum cup, component 322 can be moved to the particular location of 3D object 334 in build platform 332 such that component 322 can be placed in the particular location. The coupler including the vacuum cup that has engaged component 322 from the interaction preparation module 314 can again be moved in a first direction (e.g., the Y-direction) relative to build platform 332 by a linear actuator and in a second direction (e.g., the Z-direction) relative to build platform 332 by another linear actuator.

In some examples, interaction module 300 can be moved in a third direction (e.g., the X-direction) relative to build platform 332 independently of build material carriage 330. For example, an additional actuator can be included such that interaction module 300 can be moved in the X-direction by the additional actuator that is different from the linear actuators to move the coupler of interaction module 300 in the Y-direction and the Z-direction, respectively. In some examples, the actuator can be a belt-driven actuator in order to achieve a torque and acceleration to quickly move interaction module 300 such that the tool connected to the coupler can interact with 3D object 334. The actuator can adjust interaction module 300 independently of build material carriage 330. Therefore, the coupler including the vacuum cup that has engaged component 322 from interaction preparation module 314 can be moved in a third direction (e.g., the X-direction) relative to build platform 332 by the third actuator to allow for interaction with 3D object 334 by the vacuum cup.

In some examples, interaction module 300 can be connected to build material carriage 330. Accordingly, interaction module 300 can be moved in the X-direction by build material carriage 330. Interaction module 300 being connected with the build material carriage 330 can allow for movement of interaction module 300 without an additional actuator since interaction module 300 is connected to the build material carriage 330. This can allow for faster build times of the 3D object 334 as the movement of interaction module 300 being optimized and streamlined with the movement of the build material carriage 330. Therefore, the coupler including the vacuum cup that has engaged component 322 from interaction preparation module 314 can be moved in a third direction (e.g., the X-direction) relative to build platform 332 by the build material carriage 330 to allow for interaction by the vacuum cup with 3D object 334.

The tool connected to the coupler can be moved to the location of 3D object 334 in build platform 332 such that the tool can interact with 3D object 334. Continuing with the example from above, the tool can be a vacuum cup connected with the coupler, where the vacuum cup has engaged component 322 from the pickup platform of the interaction preparation module 314. The vacuum cup has been moved to the location of 3D object 334 in build platform 332 such that the component 322 can be placed in 3D object 334.

The component 322 can be selectively disengaged from the vacuum cup at a placement location corresponding to 3D object 334. The vacuum input to the coupler can remove the suction force engaging component 322 with the vacuum cup when component 322 is at the placement location. In some examples, the input to the coupler can provide a short pulse of gas (e.g., a short pulse of positive air pressure) to selectively disengage the component 322 from the vacuum cup.

After interaction with the 3D object 334 by the tool connected to the coupler, the tool and coupler of interaction module 300 can be moved clear of component 322/3D object 334. In an example in which interaction module 300 is not connected with build material carriage 330 and can move independently of build material carriage 330, interaction module 300 can then be moved in the X-direction to prevent obstructing build material carriage 330 from continuing the 3D print job of 3D object 334.

Although FIG. 3 includes one 3D object 334, examples of the disclosure are not so limited. For example, the 3D printer can print more than one 3D object at a time. For example, the 3D printer can print multiple 3D objects simultaneously. Further, the multiple 3D objects can be interacted with by one coupler or more than one coupler having corresponding tools simultaneously or at different times. The one coupler or more than one coupler having corresponding tools can be in a single interaction preparation sub-module of the interaction preparation module 300 or in multiple interaction preparation sub-modules.

Although system 326 is illustrated in FIG. 3 as including one interaction module 300, one interaction preparation module 314, and one component reel module 328, examples of the disclosure are not so limited. For example, an interaction module and interaction preparation module can be located on both sides of the 3D printer illustrated in system 326. In other words, system 326 can include two interaction modules, two interaction preparation modules, and in some examples, two component reel modules.

In the example described above in which system 326 can include two interaction modules and two interaction preparation modules, the interaction modules can be placed on opposing sides of the build material carriage 330 and the interaction preparation modules can be placed on opposing sides of the build platform 332. In some examples, both interaction modules and interaction preparation modules can be supplying components to be placed in 3D object 334. For example, different component reels, component trays, conveyors, and/or combinations thereof may provide components to both interaction preparation modules. In some examples, one interaction preparation module can be active (e.g., supplying components and allowing for component placement during a first portion of a print job) and one interaction preparation module can be non-active (e.g., ready to supply components and allowing for component placement during a second portion of a print job). In some examples, when system 326 includes two interaction modules, one interaction module may be connected to (e.g., to move with) build material carriage 330 and one interaction module may move independently of build material carriage 330. In some examples, when system 326 includes two interaction modules, both interaction modules may move independently of build material carriage 330.

As illustrated in FIG. 3, the system 326 can include a controller 335 The controller 335 can include a processing resource (not shown) and a memory resource (not shown). The memory resource can include machine readable instructions to cause a tool connected to a coupler to interact with a 3D object in a build platform of the 3D printer during a 3D print job, among other operations described herein.

The processing resource may be a central processing unit (CPU), a semiconductor based microprocessor, and/or other hardware devices suitable for retrieval and execution of the machine-readable instructions stored in a memory resource. The processing resource may fetch, decode, and execute the instructions to cause a tool connected to a coupler to interact with a 3D object in a build platform of the 3D printer during a 3D print job. As an alternative or in addition to retrieving and executing the instructions, the processing resource may include a plurality of electronic circuits that include electronic components for performing the functionality of the instructions.

The memory resource may be any electronic, magnetic, optical, or other physical storage device that stores the executable instructions and/or data. Thus, the memory resource may be, for example, Random Access Memory (RAM), an Electrically-Erasable Programmable Read-Only Memory (EEPROM), a storage drive, an optical disc, and the like. The memory resource may be disposed within the controller. Additionally and/or alternatively, the memory resource may be a portable, external or remote storage medium, for example, that allows the controller to download the instructions from the portable/external/remote storage medium.

Modules of 3D printers, according to the disclosure, can allow for automated interaction with 3D printed objects without delaying the 3D print job. Components which may be thicker than a layer thickness of a layer of build material can be incorporated (e.g., embedded) in the 3D object without causing print failures. The components can be parts which can be connected to conductive traces included in the 3D object. Further, the components may be quickly placed in an automated way, reducing losses in dimensional accuracy due to temperature losses in thermally prepared components, reducing and/or eliminating warping of the components and/or 3D object. Accordingly, the speed, accuracy, and viability of placement of components in 3D objects can be greatly improved, allowing for interaction with 3D objects without interfering with the workflow and/or process of applying and/or fusing layers of build material during the 3D print job.

FIGS. 4A-4D illustrate an example of a 3D print job utilizing modules of a 3D printer. For example, FIG. 4A illustrates a first portion of a 3D print job 436-1, FIG. 4B illustrates a second portion of a 3D print job 436-2, FIG. 4C illustrates a third portion of a 3D print job 436-3, and FIG. 4D illustrates a fourth portion of a 3D print job 436-4. Additionally, although 3D print job 436 is illustrated in FIGS. 4A-4D as including four portions, examples of the disclosure are not so limited. For example, 3D print job 436 can include portions of the 3D print job not necessarily illustrated in FIGS. 4A-4D. In other words, 3D print job 436 can include more than four portions.

Although not illustrated in FIGS. 4A-4D for clarity and so as not to obscure examples of the disclosure, the 3D object 434 can be located in a build platform of a 3D printer. The 3D printer can include a build material carriage. An interaction module can interact with the 3D object 434 in the build platform of the 3D printer. Additionally, the interaction module can utilize an interaction preparation module in order to interact with the 3D object 434 in the build platform of the 3D printer.

FIG. 4A illustrates an example of a 3D print job 436-1 with modules of a 3D printer consistent with the disclosure. The portion of 3D print job 436-1 can include 3D object 434.

As illustrated in FIG. 4A, 3D object 434 can be a partially 3D printed object. For example, 3D object 434 can be printed from a base 438 up to a first height 440. First height 440 can be an intermediate height of 3D object 434. That is, the 3D print job of 3D object 434 as illustrated in FIG. 4A is in progress. In some examples, during the 3D print job 436 of the 3D object 434, layers of the build material can be of varying thicknesses. For example, during placement of layers of build material when 3D object 434 is printed from base 438 up to first height 440, the thickness of the layers of build material can be thinner than when layers deposited subsequent to placement of components 422 (e.g., the layers of build material after placement of components 422 can be thicker).

During placement of the layers of 3D object 434 as 3D object 434 is printed from base 438 up to first height 440, conductive agent can be deposited on 3D object 434. For example, conductive agent, such as silver nanoparticle ink, can be selectively deposited on 3D object 434 by a printhead of the build material carriage of the 3D printer. Deposition of the conductive agent can allow for regions of 3D object 434 where conductivity is desired to be conductive. For example, the regions of 3D object 434 can be vias 444. As used herein, the term “via” refers to an electrical connection between layers of a circuit, where the circuit is through a plane of adjacent layers of a 3D object. For example, 3D object 434 can include vias 444 oriented vertically within 3D object 434. The vias 444 can facilitate an electrical circuit of a USB drive, as is further described herein with respect to FIGS. 4A-4D. Utilizing the printhead to deposit conductive agent can allow for quick deposition of conductive agent to decrease the build time of 3D object 434.

Although vias 444 are described above as being conductive agent deposited selectively by a printhead of the build material carriage of the 3D printer, examples of the disclosure are not so limited. For example, vias 444 can be deposited selectively by extruding conductive ink via a tool connected to a coupler. Utilizing the extruded conductive ink can allow for a high conductivity and/or low resistance vias, which may be desired in some examples.

As described herein with respect to FIGS. 4A-4D, 3D object 434 can be a USB drive. For example, the 3D print process illustrated in FIGS. 4A-4D can be that of a USB drive. However, examples of the disclosure are not so limited. For example, a 3D printer can utilize an interaction module and an interaction sub-module to print any other 3D object.

As illustrated in FIG. 4A, 3D object 434 can include component cavities 442-1 and 442-2. As used herein, the term “cavity” refers to a hollow space. For example, component cavities 442-1 and 442-2 can be hollow spaces in which a component of the 3D object 434 may be placed, as is further described herein. Component cavity 442-1 and component cavity 442-2 can be created during the 3D print job of 3D object 434, as is further described herein.

For example, during the 3D print job up to the point illustrated in FIG. 4A, the 3D printer may deposit layers of build material and fusing agent. The layers can be deposited successively and the layers can be fused by a lamp and the fusing agent for form 3D object 434. As described above, during deposition of the layers of build material, a conductive agent or a conductive ink may be placed selectively in regions where conductivity is desired, such as vias 444 as illustrated in FIG. 4A.

In certain portions of 3D object 434, an anti-coalescent agent may be applied to build material at locations on 3D object 434 corresponding to component cavities 442-1 and 442-2. Component cavities 442-1 and 442-2 can be created through the deposition of build material and fusing agent during one, or more than one of the layers during the 3D print job. Build material in the locations corresponding to component cavities 442-1 and 442-2 may not fuse as a result of the anti-coalescent agent. In order to create component cavities 442-1 and 442-2, tool 446 can be utilized to remove unfused (or very minimally fused) build material in the locations corresponding to component cavities 442-1 and 442-2.

As described in connection with FIGS. 1-3, an interaction module can include interaction sub-modules. The interaction sub-modules can include couplers. A coupler of an interaction sub-module can connect to a tool. The tool can be located in a tool selection sub-module of an interaction preparation module. Tools can include vacuum cups, vacuum nozzles, grippers, vacuum needles, blades, extruders, probe tweezers, lasers, among other types of tools. Tools can interact with 3D object 434 in various ways utilizing an input to the coupler. The input to the coupler can include a vacuum input, a gas input, a power input, and/or a solder paste input, among other types of inputs. The various types of inputs can allow the various types of tools to interact with 3D object 434.

A coupler in the interaction module can connect with tool 446. The coupler and attached tool 446 (e.g., a vacuum needle) can be moved to the location of 3D object 434 in the build platform of the 3D printer. The coupler can include a vacuum input to give the tool 446 suction.

The tool 446 can be moved “downwards” in the Z-direction to begin removing unfused build material from component cavity 442-1. For example, the suction force created by the input to the coupler having tool 446 attached thereto can cause the unfused build material in component cavity 442-1 to be removed. The tool 446 can be moved in the X-direction. Y-direction, and Z-direction to facilitate removal of the unfused build material from component cavity 442-1. The tool 446 can then be moved to component cavity 442-2 to remove the unfused build material from component cavity 442-2 utilizing the same process.

In some examples, tool 446 can disturb the unfused build material in order to allow it to be removed. For instance, the build material may be partially fused, and the tool 446 can “disturb” the partially fused build material to allow for the removal of the build material (e.g., the partially fused and unfused build material) from component cavities 442-1 and 442-2.

However, examples of the disclosure are not limited to the tool 446 disturbing the partially fused build material. For example, the coupler can connect with a blade such that the blade can disturb the partially fused build material.

As described above, the interaction module can include multiple interaction sub-modules. In some examples, the multiple interaction sub-modules can allow for multiple couplers to attach to multiple tools 446 (e.g., multiple vacuum needles) to allow for the simultaneous removal of build material from component cavities 442-1 and 442-2 to increase the speed of the build process of 3D object 434. In some examples, the multiple interaction sub-modules can allow for multiple couplers to attach to tool 446 and a blade and/or other combinations of tools to allow for simultaneous interaction with 3D object 434 (e.g., disturbing unfused build material and removal of unfused build material, etc.) to increase the speed of the build process of 3D object 434.

FIG. 4B illustrates an example of a 3D print job 436-2 with modules of a 3D printer consistent with the disclosure. The portion of 3D print job 436-2 can include 3D object 434 having build material removed from and components 422-1 and 422-2 placed in the component cavities 442-1 and 442-2 described in connection with FIG. 4A.

As described above, 3D object 434 may be a USB drive. In order to place components 422-1 and 422-2 in the USB drive (e.g., 3D object 434), a coupler can attach to a tool such as a vacuum cup, vacuum nozzle, or mechanical gripper. For example, a coupler can attach to tool 446 (e.g., a vacuum cup) located in a tool selection sub-module of the interaction preparation module.

The coupler including the vacuum cup can be moved to a component pickup platform of the interaction preparation module. Components 422-1 and/or 422-2 can be provided to the component pickup platform of the interaction preparation module in order to be selectively engaged by the vacuum cup. In some examples, components 422-1 and/or 422-2 can be provided to the component pickup platform of the interaction preparation module via a component reel of a component reel module. In some examples, components 422-1 and/or 422-2 can be provided to the component pickup platform of the interaction preparation module via any other method.

Components 422-1 and/or 422-2 provided to the pickup platform can be pre-heated. For example, a heater can be located in the interaction preparation module and can be utilized to pre-heat components 422-1 and/or 422-2 to thermally prepare components 422-1 and/or 422-2 for placement in order to reduce the chance that losses in dimensional accuracy of the components 422-1 and/or 422-2 and/or the 3D object 434, and/or warping of the placed components 422-1 and/or 422-2 and/or warping of the 3D object 434 being printed during the 3D print job occurs as a result of improper thermal preparation of the component.

Tool 446 (e.g., the vacuum cup) can selectively engage component 422-1. Tool 446 can engage component 422-1 by enabling a suction force created by the input to the coupler connected with tool 446 such that the suction force causes component 422-1 to engage with tool 446. An analytics system included in the interaction module can monitor whether tool 446 has engaged the correct component 422-1, whether the engagement with component 422-1 was successful (e.g., whether engagement location, component orientation, etc. is correct, whether the temperature of the engaged component is correct, etc.). If engagement with component 422-1 was successful, component 422-1 can be moved to the placement location of 3D object 434.

Once at the placement location, component 422-1 can be selectively disengaged from tool 446 to place component 422-1 in 3D object 434. The placement location of component 422-1 can correspond with component cavity 442-1. For example, the coupler including tool 446 being engaged with component 422-1 can be moved until tool 446 is located above the placement location (e.g., component cavity 442-1). Tool 446 can selectively disengage from component 422-1 at the placement location in order to place component 422-1 in 3D object 434. Tool 446 can selectively disengage from component 422-1 by removing suction by disengaging the vacuum input to the coupler connected to tool 446. In some examples, the input to the coupler can provide a short pulse of gas (e.g., a short pulse of positive air pressure) to selectively disengage the component 422-1 from the tool 446. In some examples, tool 446 can be used as a pushing implement in order to push component 422-1 into component cavity 442-1 such that component 422-1 is in the correct desired location. In some examples, a different tool may be connected to the coupler to push component 422-1 into component cavity 442-1.

The correct desired location can be a placement location such that a top surface of components 422-1 and/or 422-2 can be oriented at a same height as a top surface of 3D object 434. For example, when components 422-1 and/or 422-2 are placed in 3D object 434, a continuous surface can be created such that the 3D printer can continue to print 3D object 434 following placement of components 422-1 and/or 422-2.

Component 422-2 can be placed in 3D object 434 via the same or similar process as is described above. In some examples, tool 446 may be differently sized vacuum cups in order to selectively engage with and/or disengage from variously sized components.

As described above, the interaction module can include multiple interaction sub-modules. In some examples, the multiple interaction sub-modules can allow for multiple couplers to attach to multiple tools 446 (e.g., multiple vacuum cups, a vacuum cup and a vacuum nozzle, a vacuum cup and a mechanical gripper, and/or any other combination of tools based on the component to be selectively engaged with and/or disengaged from) to allow for the simultaneous placement of components to increase the speed of the build process of 3D object 434.

Although not illustrated in FIG. 4B for clarity and so as not to obscure examples of the disclosure, the coupler can attach to probe tweezers. The probe tweezers can be utilized to test electrical properties of the placed components 422-1 and/or 422-2. In some examples, the probe tweezers can be utilized to perform circuit analysis on the placed components 422-1 and/or 422-2 in-situ.

FIG. 4C illustrates an example of a 3D print job 436-3 with modules of a 3D printer consistent with the disclosure. The portion of 3D print job 436-3 can include 3D object 434 having components 422-1 and 422-2 placed in the component cavities 442-1 and 442-2 described in connection with FIG. 4B and electrical connections made via conductive traces 448.

As described above, 3D object 434 may be a USB drive. In order to allow the USB drive to function properly as intended, components 422-1 and/or 422-2 may be placed in 3D object 434 and electrical connections made therebetween, as is further described herein.

In order to make electrical connections in 3D object 434, a coupler can attach to tool 446 (e.g., an extruder) located in a tool selection sub-module of the interaction preparation module. For example, the extruder can be a solder paste extruder, an absorbing material extruder, an anti-coalescent material extruder, and/or a conductive ink/paint extruder. As used herein, the term “solder” refers to a metal alloy to create a bond between two objects.

For example, the solder paste extruder can extrude solder in order to create an electrical connection between components 422-1 and 422-2. For example, the input to the coupler connected to the solder paste extruder can be a gas input or a mechanical input (e.g., actuated through direct mechanical input or through an electrical input) to actuate extrusion of solder from the solder paste extruder such that the solder paste extruder can interact with 3D object 434 by applying conductive traces 448 to 3D object 434. The conductive traces 448 can be solder paste. The solder paste extruder can apply conductive traces 448 at first height 440 of 3D object 434 to connect components 422-1, 422-2, and vias 444 by an electrical circuit. Conductive traces 448 can create the electrical circuit by creating an electrical connection between components 422-1, 422-2, and vias 444.

Although tool 446 is described above as a solder paste extruder to create electrical connections between components 422-1, 422-2, and vias 444, examples of the disclosure are not so limited. For example, the tool 446 can be any other tool to apply conductive traces to connect components 422-1, 422-2, and vias 444 utilizing a conductive ink to create an electrical circuit.

Although not illustrated in FIG. 4C for clarity and so as not to obscure examples of the disclosure, the build material carriage of the 3D printer performing the 3D print job to print 3D object 434 can include lamps. The lamps can be utilized to fuse build material and fusing agent.

In some examples, the lamps of the build material carriage can be utilized to heat the conductive traces 448. Heating the conductive traces 448 can prevent conductive traces 448 and/or 3D object 434 from cooling, which could cause conductive traces 448 and/or 3D object 434 to warp.

In some examples, components 422-1 and/or 422-2 may have non-planar geometry. For example, component 422-1 can be an integrated chip having a non-planar geometry. In order to connect the integrated chip with conductive traces 448, solder paste may be applied. For example, tool 446 can be a solder paste extruder which can be connected with a coupler and moved to 3D object 434. A gas input to the coupler can cause pressure to actuate extrusion of solder paste in order to direct-write down solder paste into appropriate positions such that the integrated chip can be connected to conductive traces 448. The height of the solder paste can be kept below the first height 440 of 3D object 434 in order to allow for subsequent layers of build material to be applied to 3D object 434.

In some examples, applied solder paste may have a higher temperature in order to make appropriate electrical connections. In order to get the solder paste to the correct temperature, a laser may apply energy to the solder paste. For example, tool 446 can be a laser which can be connected with a coupler and moved to 3D object 434. An electrical input to the coupler can allow the laser to power on and direct energy to portions of the 3D object 434 to heat the solder paste to the correct temperature.

As previously described in connection with FIG. 1, the interaction module can include an analytics system. The analytics system can include various types of sensors. The analytics system can utilize temperature sensors in order to monitor the temperature of the solder paste as the laser applies energy to the solder paste to heat the solder paste. For example, the analytics system can monitor the temperature of the solder paste until the solder paste reaches a threshold temperature (e.g., ˜260° Celsius). In response to the temperature sensor determining the solder paste has reached the threshold temperature, a controller can cause the laser to stop heating the solder paste.

Although not illustrated in FIG. 4C for clarity and so as not to obscure examples of the disclosure, the coupler can attach to probe tweezers. For example, following application of the conductive traces 448, solder paste, and/or heating of the solder paste, the probe tweezers can be utilized to test electrical properties of the placed components 422-1 and/or 422-2, as well as conductive traces 448 to test the electrical circuit formed therebetween. In some examples, the probe tweezers can be utilized to perform circuit analysis on the placed components 422-1 and/or 422-2 in-situ.

Although the analytics system is described above as monitoring the temperature of solder paste, examples of the disclosure are not so limited. For example, the analytics system can monitor flow characteristics of the solder as it is being heated (e.g., via a laser profilometer or other tools), a height of the applied solder and/or a height of components 422-1 and/or 422-2, among other characteristics of 3D object 434.

FIG. 4D illustrates an example of a 3D print job 436-4 with modules of a 3D printer consistent with the disclosure. The portion of 3D print job 436-4 can include 3D object 434 having conductive traces 448 applied to electrically connect components 422-1, 422-2, and vias 444 placed in the component cavities 442-1 and 442-2 described in connection with FIGS. 4B and 4C.

After placement of components 422-1 and/or 422-2 and creation of an electrical circuit connecting components 422-1 and/or 422-2, the 3D print job can continue to apply layers of build material to 3D object 434. For example, the 30 printer may continue to apply layers of build material and fusing agent over the placed components 422-1 and 422-2. The layers can be deposited successively and can be fused by the lamp of the build material carriage and the fusing agent such that 3D object 434 can be printed from first height 440 to second height 450.

The build material from first height 440 to second height 450 can seal in components placed in 3D object 434. For example, as described above, 3D object 434 can be a USB drive. The components described above may be sealed into 3D object 434 allowing 3D object 434 to function as a USB drive.

FIGS. 4A-4D above describe a 3D print job 436 to print a 3D object 434 that is a USB drive. However, examples of the disclosure are not so limited. For example, utilizing the techniques described herein, a 3D printer may create various different types of 3D objects. For example, 3D objects may be printed during a 3D print job that work as mechanical, electrical, optical, and/or any other type of device that may be created by interaction of various tools with the 3D object. The 3D objects may include components that can be placed quickly and efficiently without placement accuracy issues, reduction in dimensional accuracy of the components, and/or warping of the placed components and/or warping of the 3D object, as well as without substantial delay in the 3D print job, allowing for a wide variety of 3D objects/devices to be created during a 3D print job.

As used herein, “a” thing may refer to one, or more than one of such things. For example, “a widget” may refer to one widget, or more than one widget.

The figures follow a numbering convention in which the first digit or digits correspond to the drawing figure number and the remaining digits identify an element or component in the drawing. Similar elements or components between different figures may be identified by the use of similar digits. For example, 100 may reference element “00” in FIG. 1, and a similar element may be referenced as 300 in FIG. 3.

The above specification, examples and data provide a description of the method and applications, and use of the system and method of the present disclosure. Since many examples may be made without departing from the scope of the system and method of the present disclosure, this specification merely sets forth some of the many possible example configurations and implementations.

What is claimed is:

1. An interaction module of a three-dimensional (3D) printer, comprising:
an interaction sub-module including:
a coupler, wherein the coupler is to connect to a tool;
a first actuator to move the coupler in a first direction; and
a second actuator to move the coupler in a second direction;
an analytics system to analyze the coupler and the tool during an interaction with a 3D object of the 3D printer;
wherein the tool of the coupler is to interact with the 3D object of the 3D printer during a 3D print job.

2. The interaction module of claim 1, wherein the coupler further includes an input for the tool such that the tool is to interact with the 3D object.

3. The interaction module of claim 2, wherein the input for the tool includes at least one of:
a vacuum input;
a gas input;
a power input; and
a solder paste input.

4. The interaction module of claim 1, wherein the tool of the coupler is of a type such that the tool is to interact with the 3D object of the 3D printer by selectively engaging a component and selectively disengaging from the component to place the component at a placement location corresponding to the 3D object.

5. The interaction module of claim 1, wherein the tool of the coupler is of a type such that the tool is to interact with the 3D object of the 3D printer by removing build material from a particular location of the 3D object.

6. The interaction module of claim 1, wherein the analytics system includes a visual sensor to monitor interaction with the 3D object, wherein interaction with the 3D object includes selectively engaging a component via the tool of the coupler from a component pickup platform and selectively disengaging from the component to place the component at a placement location corresponding to the 3D object.

7. The interaction module of claim 1, wherein the analytics system includes at least one of a temperature sensor to monitor temperature information of the component.

8. The interaction module of claim 1, wherein the analytics system is oriented at an angle relative to the interaction sub-module such that a sensor included in the analytics system has a line of sight to the interaction sub-module to analyze at least one of the coupler, the tool, and a component.

9. An interaction preparation module of a three-dimensional (3D) printer, comprising:
a tool selection sub-module, wherein the tool selection sub-module includes a plurality of tools; and
a component pickup platform to receive a component to be placed at a placement location corresponding to a 3D object of the 3D printer during a 3D print job;
wherein each tool of the plurality of tools is to be connected to a coupler such that each tool is to interact with the 3D object of the 3D printer during the 3D print job.

10. The interaction preparation module of claim 9, wherein a tool of the plurality of tools is to selectively engage the component from the component pickup platform to place the component at a placement location corresponding to the 3D object.

11. The interaction preparation module of claim 10, wherein the interaction preparation module includes a heater to heat the component to a predetermined temperature prior to the tool selectively engaging the component.

12. A system, comprising:
a three-dimensional (3D) printer including a controller;
an interaction preparation module including a tool selection sub-module having a plurality of tools; and
an interaction module, wherein:
the interaction module includes an interaction sub-module including a coupler; and
the controller is to cause the coupler to connect to a tool of the plurality of tools of the tool selection sub-module of the interaction preparation module;
wherein the controller is to cause the coupler to be moved to a location of the 3D object in a build platform such that the tool connected to the coupler is to interact with a 3D object in the build platform of the 3D printer during a 3D print job.

13. The system of claim 12, wherein the interaction module includes a movement mechanism such that the controller is to cause the movement mechanism to move the coupler in a direction relative to the build platform such that the tool connected to the coupler is to interact with the 3D object.

14. The system of claim 12, further comprising a component reel module, wherein the controller is to cause the component reel module to provide a component to a component pickup platform of the interaction preparation module to be pre-heated by a heater of the interaction preparation module, wherein the pre-heated component is to be:
selectively engaged by the tool from the component pickup platform; and
selectively disengaged from the tool at a placement location corresponding to the 3D object by the tool.

15. The system of claim 12, wherein:
the interaction preparation module includes a plurality of tool selection sub-modules;
the interaction module includes a plurality of interaction sub-modules; and
the plurality of tool selection sub-modules and the plurality of interaction sub-modules are spaced apart to cover a particular swath of the build platform of the 3D printer.
